(19) United States
(12) Patent Application Publication
(10) Pub. No.: US 2007/0047589 A1
(43) Pub. Date: Mar. 1, 2007

(54) Multi-rate SERDES receiver

(76) Inventors: Bobak Modaress-Razavi, Morrisville, NC (US); Vernon Roberts Norman, Cary, NC (US)

Correspondence Address: DILLON & YUDELL LLP, 8911 N. CAPITAL OF TEXAS HWY.,, SUITE 2110, AUSTIN, TX, 78759, US

(21) Appl. No.: 11/211,125

(22) Filed: Aug. 24, 2005

(51) Int. Cl. H04J 3/06; H04J 3/04

(52) U.S. Cl. 370/503; 370/535

(57) ABSTRACT

A serializer/deserializer (SERDES) receiver circuit designed to support multiple serial data rates (full, half, and quarter rates) based on user selection, while requiring substantially minimal amounts of additional logic and complexity within the core logic functions and analog circuits of a full rate SERDES. Over-sampled data from the analog block is provided to support each of the different rates, and the data is stored in three preliminary rate registers, one for full rate, one for half rate and one for quarter rate. In full rate mode, all samples coming from the analog circuits are utilized. In half rate and quarter rate modes, one out of every two samples and one out of every four samples is utilized, respectively. The selected samples are converted to parallel data by core logic functions, which are provided a single clock signal corresponding to the particular mode of operation.

### BACKGROUND OF THE INVENTION

1. Technical Field

The present invention relates generally to serializer/deserializer (“SERDES”) circuits and, more specifically to a SERDES receiver. Still more particularly, the present invention relates to an improved SERDES receiver and method and system for configuring/designing a SERDES receiver that supports multiple data rates.

2. Description of the Related Art

Improved efficiency in electronic data/information transfer plays a major role in the rapid advancements seen in communication technology. Traditional electronic data transfer involved the use of parallel busses/cables coupled between a transmission device and a receiving device. In more conventional systems, which typically require significantly more bandwidth and reliability of received data, serial backplanes (or busses) have become the norm by which a majority of these transfers are completed.

Typically, serial backplanes employ a serializer at a transmitting end to convert and transmit data in serial order and a deserializer at the receiving end to convert the data back to parallel form once received. Such serializer/deserializer (SERDES) transceivers have become the benchmark for asynchronous communication. Thus, in the field of serial communications involving data transfers between integrated circuits or systems, it is common practice to exchange data between a SERDES transmitter circuit and a SERDES receiver circuit. Within a conventional serial bus, each line of communication includes a separate SERDES transceiver, each having a SERDES transmitter and receiver, for serializing and deserializing each flume of data, respectively. In each SERDES receiver circuit, the receiving circuitry is usually provided with a clock and data recovery (CDR) circuit connected in series with the deserializer circuit that is in charge of extracting a clock signal from the incoming serial data stream.

SERDES receivers utilize a single clock signal for component and signal synchronizing, and the receiving and transmitting ends of a SERDES transceiver are synchronized by monitoring the transmitted data. The SERDES receiver will use a locally generated clock to recover and package the serial data into parallel data. There is typically a small difference in frequency, measured in a few hundred parts per million (ppm), between the locally generated clock of the SERDES receiver and the frequency of the clock that is based on the recovered parallel data. The recovered parallel data is then sent to the user of the SERDES receiver along with a clock that matches the frequency of the recovered parallel data.

Within the serial communication technology space, there is a growing desire for high speed serial links with the ability to cover a wide range of supported speeds. However, along with the desire for faster and more efficient serial communication, many users still request circuits that are able to accommodate slower speeds (e.g., half rate and quarter rate speeds) so that their legacy serial link systems/applications can be supported as the user makes a gradual transition to the faster speed. Because of limitations in analog phase lock loop (PLL) ranges, the slower half and quarter rate speed within the serial link speed range is generated in the logic of the serial link core.

Usually, the CDR is accomplished by over-sampling the incoming serial data with several phase shifted clocks produced by analog circuits. The resulting over-sampled data is processed by the logic which produces clock recovery information that is fed back to the analog circuits. For example, in a two-bit receiver, the analog circuit over-samples two serial bits with four phase shifted clocks. The phase shifted clocks used to over-sample the serial data are half the speed of the incoming serial data and each incoming serial data bit is sampled by two phase shifted clocks.

FIG. 1 provides a clock diagram illustrating a conventional SERDES receiver circuit that is designed to support slower (half and quarter rate) speeds. Each block represents a function required by SERDES receivers. These blocks will have to adjust and behave differently for the different rates supported (full, half, and quarter rate). The descriptions therefore are of the functions provided at each block and the arrows depict general propagation of inputs/signals to specific functions of the SERDES receiver. As illustrated in FIG. 1, SERDES receiver 100 includes a rate register 106 which receives full rate over-sampled data 102 from the analog block (i.e., the transmission source). Rate register 106 also receives a clock input 104 from the analog block. Four flip flops are provided within the rate register 106 to hold samples of the sampled data received from the analog block.

From rate register 106, the sampled data is provided to two logic functions, which each receives three clock inputs, a full rate clock, a half rate clock and a quarter rate clock input, labeled 105 in the figure. Two additional logic functions are illustrated in sequence with the two functions which receive the sampled data inputs. For simplicity in distinguishing these four logic functions from each other, they are hereinafter referred to by number (e.g., logic function 1, logic function2, and so on) according to their respective location within the figure. Thus, logic function1 108 and logic function3 112 are the two which receive the sampled data as inputs from rate register 106.

Logic function1 utilizes the edge positions in the over-sampled serial data received from rate register 106 to calculate and send a phase adjustment command to the analog rotator circuit (not shown) for clock and data recovery (CDR). Logic function2 110 receives input from customer logic (illustrated by input arrow from below) outside of the SERDES core and also receives the three clock inputs. Logic function2 110 provides a single bit shift of the parallel data alignment when directed to do so by the customer logic. Logic functional3 112 receives the (adjusted) parallel data alignment from logic function2 110 and packages up the serial data received from rate register 106 into the width requested by the customer. Logic function3 112 performs the alignment of parallel data according to the alignment determined by the second functional block 112. Finally, logic function4 114 receives all three clock inputs and provides a clock signal with the correct frequency clock to the customer. The clock signal is transferred along with the transfer of the parallel data from logic function3 112. According to conventional application, the frequency of the clock generated by logic function4 114 will have to be adjusted for each of the parallel data widths and for each of the three rates.

FIG. 1 illustrates only the basic operation of a prior art approach to handling data that may be provided is at one or the other of the three data rates (full, half, or quarter rate). To enable each logic function to support all three clock rates, significant amounts of additional logic are required within each of the logic functions. Notably, conventional serial link receivers have utilized logic modifications in multiple places to handle the different required rates. The complexity and area required for the additional logic results in a restriction in the number of rates offered/supported by any of the conventional designed SERDES receivers to a single, primary rate. Legacy systems (operating at half and quarter rates) are thus not typically supported by newer SERDES receivers designed to operate at the faster/full rates.

### SUMMARY OF THE INVENTION

Disclosed is a serializer/deserializer (SERDES) receiver circuit designed to support each of multiple serial data rates (full, half, and quarter rates) based on contemporaneous user selection, while requiring substantially minimal amounts of additional logic and complexity within the core logic functions and analog circuits of a full rate SERDES. Over-sampled data from the analog block are provided to support each of the different rates, and the over-sampled data is stored in three preliminary rate registers, one for full rate, one for half rate and one for quarter rate.

The analog circuits are optimized for the fastest and most difficult to support serial link speed (i.e., full rate), and the logic changes how data coming from the analog circuits is interpreted based on which rate the user of the core has requested. The analog circuits over-samples the serial data, and the logic then decides which samples are to be used for each of the three different supported rates (full, half, and quarter). In full rate mode, all samples coming from the analog circuits are utilized. In half rate mode, one out of every two samples is utilized. In quarter rate mode, one out of every four samples is utilized. This allows the handling of the half and quarter rate modes in the first few stages of the logic. These selected samples are then forwarded to the core logic functions via a rate adjustment register.

A single clock signal, associated with a specific one of the rates (full, half, or quarter) and determined based on received user input, is generated/selected and fed to each of the functions, including the core logic functions. The effective clock and data recovery (CDR) performance is also kept equivalent for all modes. In one implementation, a history of the over-sampled serial data is maintained for the half and quarter rate modes when necessary. When either of those modes has been selected by the user, the clock rate fed to the core logic is reduced in every other portions of the logic to reflect that rate. When user input is not received, the clock signal and logic operations default to full rate operation.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram representation of main function blocks/logic of a SERDES receiver which requires additional logic at every functional block because of the added complexity of handling the three modes (full, half, and quarter rate) with three clock inputs;

FIG. 2 is a block diagram representation of an enhanced multi-rate SERDES receiver designed according to features of one embodiment of the present invention; and

FIG. 3 is a timing diagram of the functioning of the multi-rate SERDES receiver performing deserializing operations at each of the supported rates in accordance with one embodiment of the present invention.

### DETAILED DESCRIPTION OF AN ILLUSTRATIVE EMBODIMENT

The present invention provides a serializer/deserializer (SERDES) receiver circuit designed to support each of multiple serial data rates (full, half, and quarter rates) based on contemporaneous user selection, while requiring substantially minimal amounts of additional logic and complexity within the core logic functions and analog circuits of a full rate SERDES. Over-sampled data from the analog block are provided to support each of the different rates, and the over-sampled data is stored in three preliminary rate registers, one for full rate, one for half rate and one for quarter rate.

The analog circuits are optimized for the fastest and most difficult to support serial link speed (i.e., full rate), and the logic changes how data coming from the analog circuits is interpreted based on which rate the user of the core has requested. The analog circuits over-samples the serial data, and the logic then decides which samples are to be used for each of the three different supported rates (full, half, and quarter). In full rate mode, all samples coming from the analog circuits are utilized. In half rate mode, one out of every two samples is utilized. In quarter rate mode, one out of every four samples is utilized. This allows the handling of the half and quarter rate modes in the first few stages of the logic. These selected samples are then forwarded to the core logic functions via a rate adjustment register.

A single clock signal, associated with a specific rate (full, half, or quarter) determined by the user, is generated/selected and fed to each of the functions, including the core logic functions. The effective clock and data recovery (CDR) performance is also kept equivalent for all modes. In one implementation, a history of the over-sampled serial data is maintained for the half and quarter rate modes when necessary. When either of those modes has been selected by the user, the clock rate fed to the core logic is reduced in other portions of the logic to reflect that rate. When user input is not received, the clock signal and logic operations default to full rate operation.

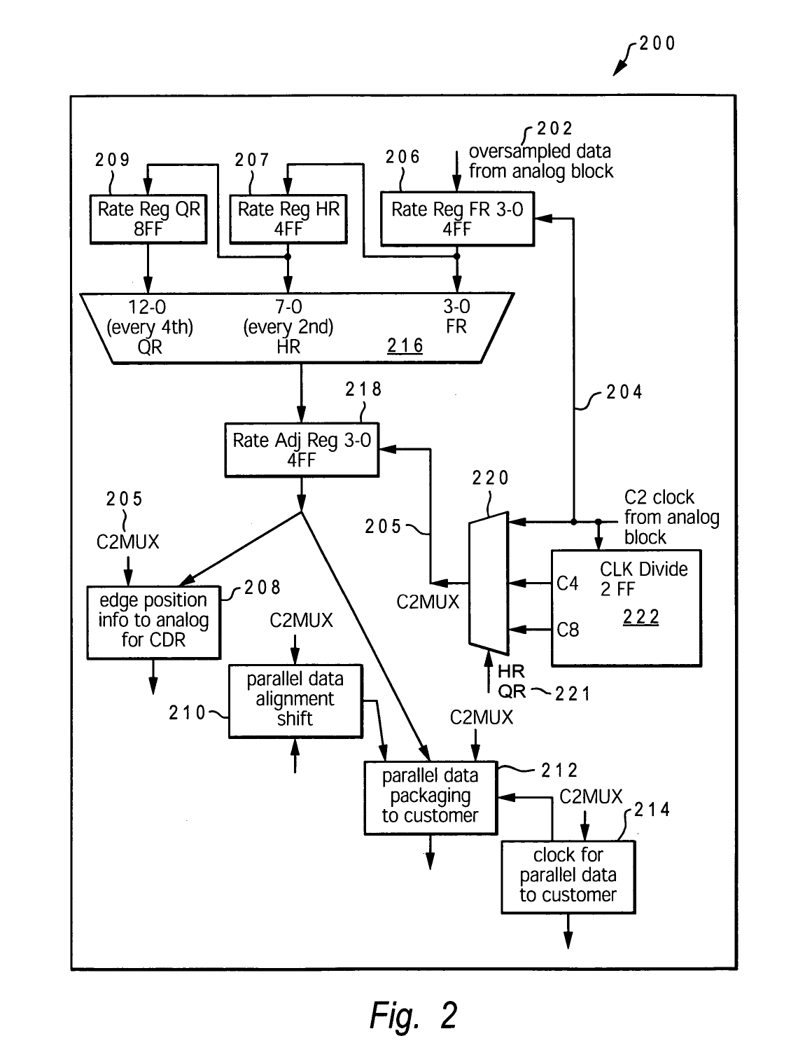

Referring now to FIG. 2, there is illustrated a block diagram of an enhanced multi-rate SERDES receiver 200, designed according to one embodiment of the present invention. Each block represents a function provided via hardware logic or software logic. The descriptions therefore are of the logic functions provided at each block and the arrows depict general propagation of inputs/signals to specific functions of the multi-rate SERDES receiver.

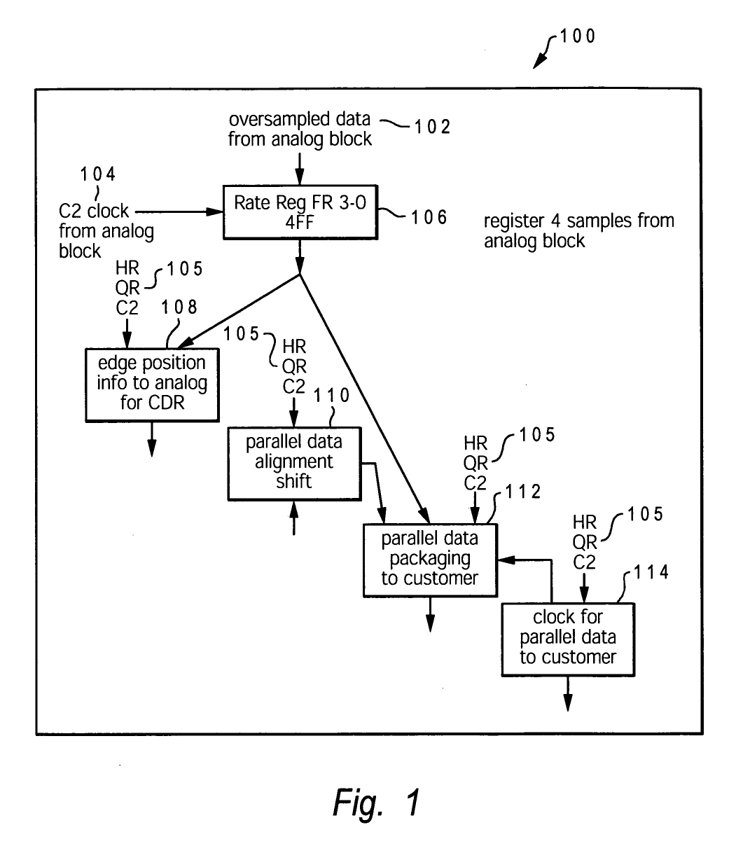

FIG. 2 provides an exemplary embodiment of a multi-rate SERDES receiver configured according to the principles of the present invention. Unlike conventional SERDES receivers, e.g., the SERDES receiver configured according to FIG. 1, the multi-rate SERDES receiver of the present invention includes several enhancements that allow the multi-rate SERDES receiver to provide support for multiple different data rates without adding logic to the receiver's core logic functions. That is, in order to handle multiple serial data rates without the substantial additional logic built into the primary function blocks, the over-sampled data coming from the analog block is used in such a way as to allow the core logic functions (i.e., blocks 108-112) to operate the same in all modes (i.e., full, half, and quarter rate). This configuration reduces the complexity of the four main logic functions (i.e., blocks 108-112).

Thus, as shown, over-sampled data 202 from the analog circuit is received and placed in full rate register 206, which contains all the samples needed for full rate operation. The full, half, and quarter rate registers 206, 207, and 209 also receives the unmodified clock input 204 from the analog block. Rate register 206 includes four flip flops which contain the four over-sampled data bits coming from the analog circuits. Half rate register 207 and quarter rate register 209 are utilized to keep a history of samples from the previous clock inputs 204. As noted above, for full rate operation (which is the default operation mode for MR SERDES receiver), full rate register 206 contains all samples required for full rate processing and all samples within full rate register 206 are utilized. When in half rate operation, however, only every other sample is utilized from the combination of full rate registers 206 and half rate register 207. Further, only every fourth sample is utilized from the combination of registers 206, 207, and 209 when in quarter rate operation.

Notably, quarter rate register 209 has a total of 8 flip flops compared to 4 for each of full rate register 206 and half rate register 207. The number of flip flops within each register is for illustrative purposes only and may be different for alternative embodiments. For actual implementation, only two flip flops may be actually needed/utilized within half rate operation (which requires only every other sample) and an additional two for quarter rate operation (which requires one for every four samples of 16 bits of sample history). The half rate and quarter rate registers contain a history of sample data from the previous clock cycles(s).

From rate adjustment register 218, the sampled data is provided to two logic functions, which each receives a single clock 205 which is at the correct rate, and thus does not require the additional logic as those conventional logic functions provided within FIG. 1. That is, with the MR SERDES of the illustrative embodiment, the selection of the rate and thus the clock occurs prior to the selection of sampled data to forward to these logic functions. With the configuration of FIG. 1, each function block must behave differently in full, half, and quarter rate modes. This adds complexity (requiring additional logic and space) to each block, which must account for multiple possible clocks inputs. However, with the illustrative embodiment of the present invention, because the data is itself already sampled to account for the half rate and quarter rate, only the correct rate type is passed to the function blocks and only the single multiplexed clock output is provided as the clock input to each function.

Thus, the sampled data within rate adjustment register 218 is forwarded to logic functions 208 and 212, and each logic function further receives a single clock 205. Two additional logic functions are illustrated in sequence with the two logic functions which receive the sampled data inputs. For simplicity in distinguishing these four logic functions from each other, they are hereinafter referred to by number (e.g., logic function1, logic function2, and so on) according to their respective location within the figure. Thus, logic function1 208 and logic function3 212 are the two which receive the sampled data as inputs from rate adjustment register 218.

Logic function1 208 receives the edge position (Ex) data from rate adjustment register 218 and uses that data to update controls going to the analog block to enable the slight movement of the sampling clocks earlier or later in time to keep the clocks in the correct sampling region. These small consecutive clock movements over time will look like a small frequency offset clock which corresponds to the frequency of the incoming serial data. Since logic function1 208 is not changed but simply running at a slower clock frequency in the slower rates (half and quarter), there is no difference in the effectiveness of the CDR algorithm in the different rates.

Logic function2 210 receives input from user/customer logic (illustrated by input arrow from below) outside of the SERDES core and based on that user input, provides a parallel data alignment shift. The user of SERDES receiver signals logic function2 210 when to change the alignment of the parallel data based on the specific byte boundary desired. Logic function3 212 adjusts the parallel data alignment based on the state of logic function2 210 and also receives the data samples (Dx) from rate adjustment register 218 which is packaged up as parallel data and sent to the user of the receiver SERDES. Finally, logic function4 214 creates the correct frequency clock for the parallel data being delivered to the user/customer.

Additional preliminary registers (i.e., half and quarter rate registers that maintain the history of data samples used during half rate and quarter rate modes and data sample compiler logic 216) are added to the enable the MR SERDES receiver to account for multiple different rates. Once the data is correctly sampled and the sampled data placed in rate adjustment register 218, core logic functions are utilized to further handle whatever processing/operations are provided on the sampled data without consideration for multiple rates and multiple clock inputs, etc. Thus, the new multi-rate SERDES receiver supports both newer systems and legacy systems operating at half or quarter speeds. The ability to provide such support within newer SERDES receivers ultimately allows a gradual conversion to the higher speed system by customers/users.

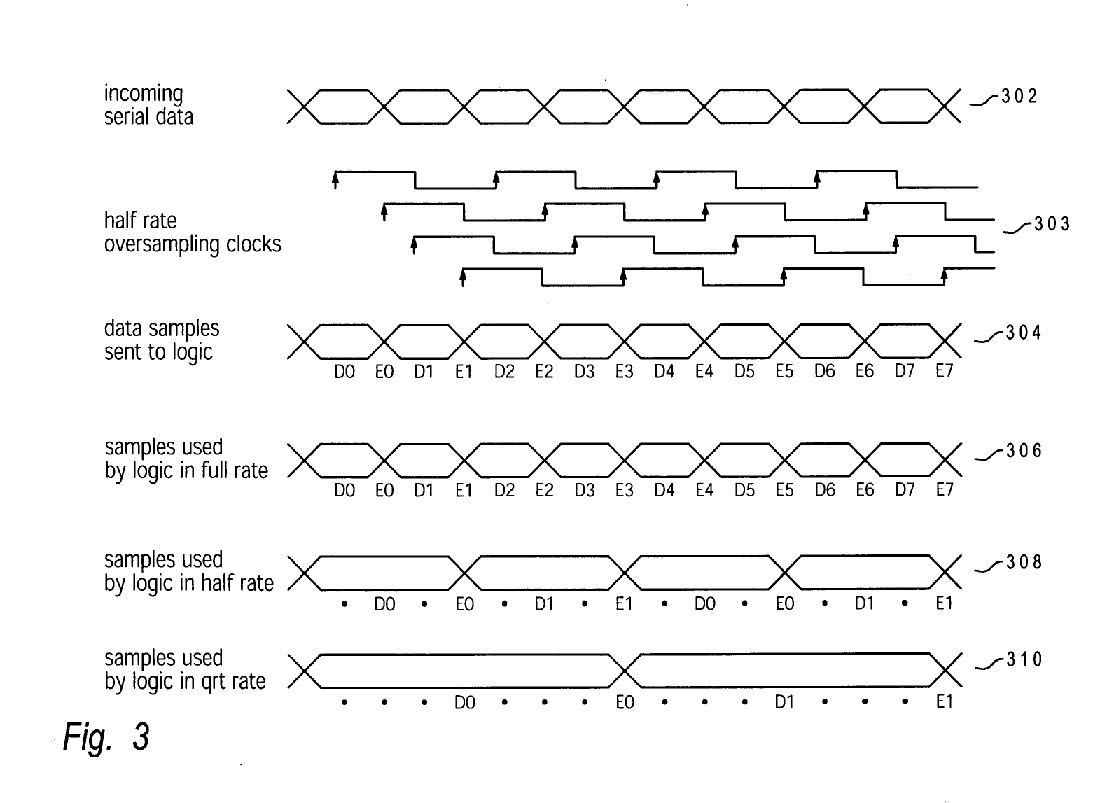

Further description of FIG. 2 makes reference to FIG. 3, which illustrates a timing chart of multiple sample rates produced by the multi-rate SERDES receiver according to one embodiment of the invention. According to the illustrative embodiment, the two samples for each serial bit are called Dx and Ex (where “x” represents an integer defining the specific data sample). FIG. 3 is divided into multiple sections. The top portion of FIG. 3 depicts the serial data and over-sampling clocks. The below portions of FIG. 3 shows the over-sampled data which is sent to the core logic functions. For example, on every clock cycle 204, the receive logic receives four samples (D0-E1, D2-E3, etc).

The description now refers again to FIG. 2, with occasional reference to FIG. 3. When in full rate mode, clock selection multiplexer 220 passes clock 205 through to the C2MUX net. There is no difference in the clock frequency of registers 206 and 218 and all four samples are transferred and used on every clock cycle 205. As indicated by FIG. 3, lines 304 and 306 illustrate the transfer of four samples in the full rate case. Each clock cycle 205 produces four samples. For example, D0, E0, D1, and E1 would be produced by the analog circuits and used by the logic functions on one clock cycle in full rate mode. Regardless of what rate the receiver is being asked to accomplish, the logic will have two over-sampled pieces of information for each serial bit. One piece will correspond directly to the data (Dx) and another will correspond to the edge position (Ex) of the serial data with respect to the clocks that are over-sampling the data.

When in half rate mode, the clock selection multiplexer 220 passes a divide-by-two version (i.e., clock cycle 205) of the clock 204 coming from the analog block. In this mode, there is a transfer of data from every other bit in the half rate register 207 and full rate register 206 to the rate adjustment register 218. The rate adjustment register 218 and all the other required logic functions will receive and operate with the divide-by-two version of the clock 204 coming from the analog block.

Again, in FIG. 3, lines 304 and 308 show this transfer of four samples in the half rate case. Two clock cycles 205 produces eight samples held in the 207 and 206 registers which are then moved into the 218 register running on the divide by two version of the clock coming from the analog block. For example, D0-E3 (304) would be produced by the analog circuits and only four specific samples (308) would be used by the logic on one clock cycle 205 in half rate mode.

Similarly to above, for quarter rate mode, the clock selection multiplexer 220 passes a divide-by-four version of the clock 204 coming from the analog block. There is a transfer of data from every fourth bit in the quarter rate register 209, half rate register 207, and full rate register 206 to the rate adjustment register 218. The rate adjustment register 218 and all remaining required logic functions will run on the divide-by-four version of the clock 204 coming from the analog block.

In FIG. 3, lines 304 and 310 show this transfer of four samples in the quarter rate case. Four clock cycles 205 produces sixteen samples held in quarter, half and full rate registers 209, 207, and 206, and one out of every four of the sixteen samples are then moved into the rate adjustment register 218 running on the divide-by-four version of the clock 204 coming from the analog block. For example, D0-E7 (304) would be produced by the analog circuits and only four specific samples (310) would be used by the logic on one clock cycle 205 in quarter rate mode.

With the illustrative embodiment of the invention, the multi-rate SERDES (serial link) receiver provides the following four functions among others:

taking serial data and packaging that data into different width parallel data buses (e.g., 8, 10, 16, and 20 bits);

creating a clock with the correct period that goes along with the parallel data (e.g., in 10 bit mode, the clock will have a period of 10 bit times);

changing the alignment of the parallel data (e.g., if the receiver detects five 1's and five 0's serially, it could come out as 0000111110 on the parallel data bus when the customer is really looking for 0000011111. In that case the customer would want the parallel data alignment changed by 1 bit position); and determine serial data edge positions for clock recovery purposes.

The described embodiment of the present invention recognizes that all of the above functions behave differently when in half or quarter rate mode compared to full rate mode. The analog circuits are designed to work in a narrow operating range, and the logic handles the half and quarter rate operation. In the half rate mode, for example, the clock sent to the customer along with the parallel data will have a period of 10 half rate bit times instead of 10 full rate bit times.

The solution provided by the described embodiments of the invention utilizes/requires very little additional logic to create half and quarter rate receiver operation. According to the embodiment, the majority of the logic needed for full rate operation is simply re-used for the half and quarter rate. The receiver analog circuits are not affected and effective CDR (clock/data recovery) performance is kept equivalent for all modes.

More specifically, the described embodiment of the invention addresses the desire for high speed serial links with the ability to cover a wide range of supported speeds and provide customers with systems that can continue to be used in older legacy serial link applications, which allows a gradual conversion to the higher speeds.

The present invention provides a solution that handles the oversampled data to easily come up with full, half, and quarter rate SERDES receiver functions without changing the core logic functions. The invention primarily focuses on functions in the serial link (i.e., the physical level rather than the application level) that completes the clock and data recovery at different rates. Notably, functions of the invention may be carried out within a data processing system and programmed as code within the data processing system or on a medium capable of being read/accessed by the data processing system. The multi-rate (MR) SERDES receiver enables utilization of slower serial link receiver data rates for legacy applications, with very little added logic, complexity and area.

It is therefore important that while the illustrative embodiment of the present invention has been, and will continue to be, described in the context of a fully functional system with installed logic, those skilled in the art will appreciate that certain logic aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A serializer/deserializer (SERDES) receiver comprising:
a set of rate registers with (a) a first full rate register that receives over-sampled data from an analog circuit within a first clock cycle of a full rate clock input and (b) at least one other rate register that receives historical sampled data from a previous clock cycle and which supports sampling data for use in a different rate operation mode other than full rate operation mode;
a clock selection logic that receives full rate clock input from an analog circuit and generates a plurality of different-rate clock outputs, one of which is selected as a single clock input that is fed into all logic components to trigger a particular rate operation mode from among multiple possible rate operation mode; and
a set of core logic functions that receive the single clock input and a set of N sampled data selected from one or more of the set of rate registers depending on the particular rate operation mode, and wherein said core logic functions operate to generate a deserialized (parallel) data output at the particular rate operation mode from the set of N sampled data and the single clock input.

2. The SERDES receiver of claim 1, further comprising:
a rate selection/sampling logic that extracts/receives from the set of rate registers the set of N sampled data including over-sampled data from the full rate register and, when a different particular rate operation mode is being supported, historical sampled data from at least one of the other rate registers.

3. The SERDES receiver of claim 2, wherein:
the set of registers further include a half rate register and a quarter rate register; and
said sampling logic includes logic for:
selecting N data samples from the full rate register for full rate operation, where N is the total number of data samples required by the core logic to generate the parallel data;
selecting ½N data samples from each of the full rate register and the half rate register for half rate operation; and
selecting ¼N data samples from each of the full rate register and half rate register and ¼N from the quarter rate register; and

4. The SERDES receiver of claim 1, further comprising logic associated with the set of rate registers for forwarding N selected data samples to a rate adjustment register, which provides said N selected data samples to a first logic function and a second logic function of the core logic functions.

5. The SERDES receiver of claim 2, wherein said other rate register receives an input of sampled data from the full rate register from a previous clock cycle and stores said sampled data as a history of sampled data, such that a half-rate register stores the sampled data from a previous clock cycle and a quarter rate register stores the sampled data from two previous clock cycles ago, and so on.

6. The SERDES receiver of claim 1, further comprising:
a clock divide logic that receives as input the full rate clock and which generates both a half rate clock and a quarter rate clock;
a clock multiplexer (MUX) that selectively chooses one of the full, half and quarter rate clocks to forward to the logic components, which selection is triggered by a user input of the desired rate to apply to the logic components.

7. The SERDES receiver of claim 1, wherein the set of rate registers, the rate selection logic, and clock divide logic and clock MUX are external components coupled to inputs of standard single-rate SERDES logic components.

8. A network device comprising:
an analog circuit for receiving serialized data and which includes a full rate clock and logic for over-sampling said serialized data to produce over-sampled data;
a multi-rate SERDES receiver that includes:
a set of rate registers with (a) a first full rate register that receives over-sampled data from an analog circuit within a first clock cycle of a full rate clock input and (b) at least one other rate register that receives historical sampled data from a previous clock cycle and which supports sampling data for use in a different rate operation mode other than full rate operation mode;
a clock selection logic that receives full rate clock input from an analog circuit and generates a plurality of different-rate clock outputs, one of which is selected as a single clock input that is fed into all logic components to trigger a particular rate operation mode from among multiple possible rate operation mode; and
a set of core logic functions that receive the single clock input and a set of N sampled data selected from one or more of the set of rate registers depending on the particular rate operation mode, and wherein said core logic functions operate to generate a deserialized (parallel) data output at the particular rate operation mode from the set of N sampled data and the single clock input;

9. The network device of claim 8, wherein the SERDES receiver further comprises:
a rate selection/sampling logic that extracts/receives from the set of rate registers the set of N sampled data including over-sampled data from the full rate register and, when a different particular rate operation mode is being supported, historical sampled data from at least one of the other rate registers.

10. The network device of claim 9, wherein:
the set of registers further include a half rate register and a quarter rate register; and
said sampling logic includes logic for:
selecting N data samples from the full rate register for full rate operation, where N is the total number of data samples required by the core logic to generate the parallel data;
selecting ½N data samples from each of the full rate register and the half rate register for half rate operation; and
selecting ¼N data samples from each of the full rate register and half rate register and ½N from the quarter rate register.

11. The network device of claim 1, said SERDES receiver further comprising logic associated with the set of rate registers for forwarding N selected data samples to a rate adjustment register, which provides said N selected data samples to a first logic function and a second logic function of the core logic functions.

12. The network device of claim 9, wherein said other rate register receives an input of sampled data from the full rate register from a previous clock cycle and stores said sampled data as a history of sampled data, such that a half-rate register stores the sampled data from a previous clock cycle and a quarter rate register stores the sampled data from two previous clock cycles ago, and so on.

13. The network device of claim 8, wherein the SERDES receiver further comprises:
a clock divide logic that receives as input the full rate clock and which generates both a half rate clock and a quarter rate clock; and
a clock multiplexer (MUX) that selectively chooses one of the full, half and quarter rate clocks to forward to the logic components, which selection is triggered by a user input of the desired rate to apply to the logic components.

14. The network device of claim 8, wherein the set of rate registers, the rate selection logic, and clock divide logic and clock MUX are external components coupled to inputs of standard, single-rate SERDES receiver components.

15. A computer implemented method comprising:
receiving a plurality of sets of N over-sampled serial data during a sequential full clock cycles;
allocating a first register within memory of a device implementing the method as a full-rate register;
placing a first set of N over-sampled serial data in the full-rate register during a first sampling clock cycle;
allocating a second register as a half-rate register and a third register as a quarter rate register;
during a next sampling clock cycle, moving the first set of N over-sampled serial data to the half rate register and placing a next set of N over-sampled serial data in the full rate;
subsequently shifting the first and next sets of N over-sampled serial data to the quarter rate register and half rate register, respectively, while placing a third set of N over-sampled serial data in the full rate register;
determining which operation mode of a plurality of operation modes, from among full rate, half rate and quarter rate operation modes, is to be implemented; and
performing conversion to parallel data of N selected ones of serial data within the registers, said N serial data selected based on the operation mode implemented, wherein when full rate operation mode is implemented, all N serial data is selected from the full-rate register, when half rate operation mode is implemented, ½N of serial data is selected from full rate register and the remaining ½N selected from half rate register, and when quarter rate operation mode is implemented, ½N of serial data is selected from quarter rate register, ¼N from full rate register and the remaining ¼N selected from half rate register.

16. The method of claim 15, further comprising:
receiving a user input indicating an operation mode desired for converting received serialized data; and
dividing a full rate clock input determined from the received serialized data by a factor that reduces the full rate clock input to the rate associated with the operation mode desired; and
subsequently utilizing the divided clock input as the input clock signal for all functions involving the conversion of the serialized data into parallel data.

17. A computer program product having a computer readable medium and program code on the computer readable medium for performing the method steps of claim 10.
